(19) United States
(12) Patent Application Publication
(10) Pub. No.: US 2008/0103862 A1
(43) Pub. Date: May 1, 2008

(54) INSTANT MESSAGED FORMS BASED BUSINESS PROCESS DECISION POINT FACILITATION

(75) Inventors: Harold Moss, Danvers, MA (US); Ajamu Wesley, Raleigh, NC (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: International Business Machines Corporation, Armonk, NY (US)

(21) Appl. No.: 11/553,671

(22) Filed: Oct. 27, 2006

(51) Int. Cl. G06Q 10/00; G05B 19/418; G06Q 30/00; G06F 9/46

(52) U.S. Cl. 705/8; 705/1

(57) ABSTRACT

Embodiments of the present invention address deficiencies of the art in respect to decision point management for a business process and provide a method, system and computer program product for instant messaging forms based business process decision point facilitation. In one embodiment of the invention, a method for instant messaged forms based business process decision point facilitation can be provided. The method can include detecting a decision point in a business process, identifying a target collaborator for the detected decision point, applying instant messaging presence awareness for the target collaborator, and forwarding a form within an instant message to the target collaborator only when the target collaborator is determined to be present for instant messaging.

### BACKGROUND OF THE INVENTION

1. Field of the Invention

The present invention relates to the field of business process management in a collaborative environment and more particularly to managing decision points in a business process to decision point closure.

2. Description of the Related Art

Business process refers to a flow of activities performed by a team of collaborators to achieve a process end point. Classic business processes include product purchasing and software development. Decision points form an integral part of any business process. In a decision point, one or more of the collaborators must provide some sort of input in order for the business process to advance to closure. In most cases, decision points in a business process involve the approval or denial of a request by another collaborator to the business process.

Prior to the wide scale usage of the Internet, most business processes were manual processes, rife with paper work and informal and undocumented oral communications. Consequently, managing the interactions in a decision point often involved a hit-or-miss, person-to-person, manual exchange requiring close geographic proximity of all collaborators, or tedious paper forms based exchanges including latencies associated with the physical movement of paper forms from one collaborator to another. In view of the inadequacies of manually implemented business processes, it is no wonder that the Internet revolutionized the effectiveness of the modern business process enabling new collaborations both within a single organization and among multiple, communicatively coupled organizations.

The advent of the Internet has resulted in the widespread connectivity of collaborators without regard to the geographical proximity of collaborators to a business process. Complex arrangements of distributed logic now orchestrate the day to day activities in a business process across multiple collaborators. Still, some of the inefficiencies of the pre-Internet remain. In particular, decision points remain bottlenecks for attaining closure in a business process. The inaction of a single collaborator can bring a business process to a grinding halt. In many cases, collaborators responsible for a decision point merely can be so busy as to forget to complete the most simple of all tasks—the approval of an activity in a business process.

### BRIEF SUMMARY OF THE INVENTION

Embodiments of the present invention address deficiencies of the art in respect to decision point management for a business process and provide a novel and non-obvious method, system and computer program product for instant messaging forms based business process decision point facilitation. In one embodiment of the invention, a method for instant messaged forms based business process decision point facilitation can be provided. The method can include detecting a decision point in a business process, identifying a target collaborator for the detected decision point, applying instant messaging presence awareness for the target collaborator, and forwarding a form within an instant message to the target collaborator only when the target collaborator is determined to be present for instant messaging.

The method further can include receiving from the target collaborator a reply instant message, determining from the reply instant message whether the decision point has been resolved, and driving the business process towards closure if the reply instant message is determined to have satisfied the decision point. In one aspect of the embodiment, forwarding a form within an instant message to the target collaborator only when the target collaborator is determined to be present for instant messaging can include encapsulating a request for information in a form for an instant message and instant messaging the instant message to the target collaborator.

In another aspect of the invention, applying instant messaging presence awareness for the target collaborator, can include applying the extensible messaging and presence protocol (XMPP) to detect presence for the target collaborator. As it will be understood by the skilled artisan, XMPP, is an open, extensible markup language (XML) based protocol for near-real-time, extensible instant messaging and presence information. As such, encapsulating a request for information in a form for an instant message can include applying the XMPP to create the form within the instant message.

In another embodiment of the invention, an instant messaged forms based business process decision point facilitation data processing system can be provided. The system can include an instant messaging server, a business process host platform supporting a business process through a process manager and a process data store, an instant messaging bot configured to apply instant messaging presence awareness to a plurality of collaborators associated with the business process, and decision point closure facilitation logic coupled to the business process host platform. The logic can include program code enabled to, in response to encountering a decision point in the business process for a target collaborator, forwarding a form for the decision point within an instant message to the target collaborator only when presence is detected by the instant messaging bot for the target collaborator.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a schematic illustration of a collaborative data processing system configured for instant messaged forms based business process decision point facilitation; and,

FIGS. 2A and 2B, taken together, are a flow chart illustrating a process for instant messaged forms based business process decision point facilitation.

### DETAILED DESCRIPTION OF THE INVENTION

Embodiments of the present invention provide a method, system and computer program product for instant messaged forms based business process decision point facilitation. In accordance with an embodiment of the present invention, an automated business process can be configured for multiple different collaborators to include at least one decision point within the automated business process. The decision point can be associated with a particular one of the collaborators. Upon encountering the decision point, presence awareness can determine the instant messaging availability of the particular one of the collaborators. If the particular one of the collaborators is available, the requisite information to drive past the decision point towards closure of the business process can be incorporated into an instant messaging form and forwarded by way of an instant messenger to the particular one of the collaborators. Thereafter, the form in its electronic form can be completed within the instant messenger and returned by way instant messaging to the business process thereby clearing the decision point in the business process.

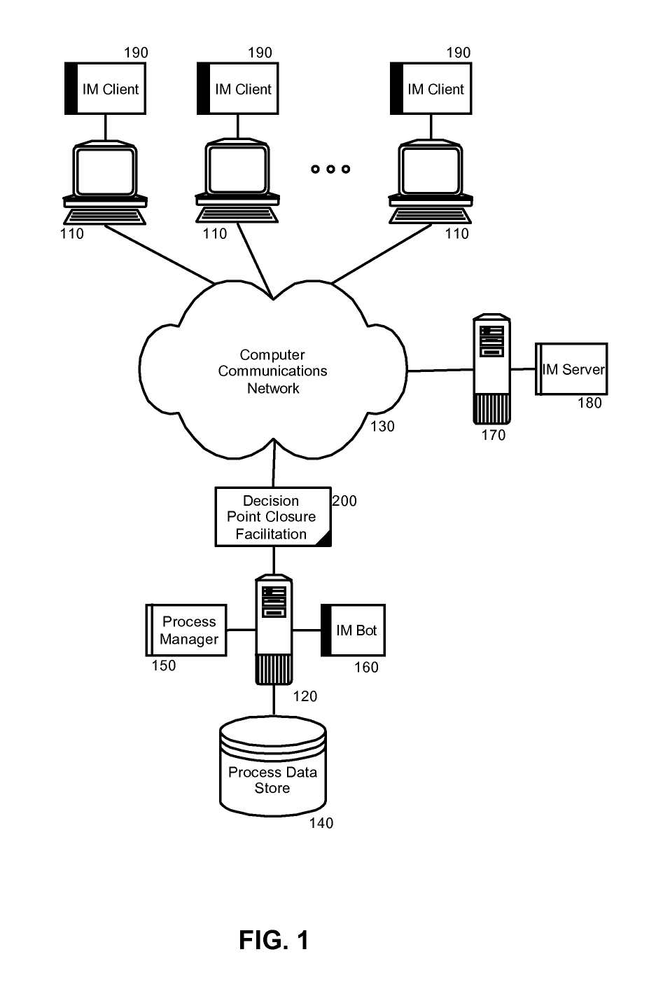

In further illustration, FIG. 1 is a schematic illustration of a collaborative data processing system configured for instant messaged forms based business process decision point facilitation. The system can include one or more collaborative computing clients 110 coupled to one another over a computer communications network 130. Each of the collaborative computing clients 110 can further be coupled to a business process platform host 120 over the computer communications network 130. Notably, the business process platform host 120 can support the operation of a business process through a process manager 150 and associated process data store 140. In this regard, the process manager 150 can establish and maintain the sequence and execution of different steps in a business process utilizing the process data store 140 to store information pertaining to the business process.

Each of the collaborative computing clients 110 additionally can be coupled to an instant messaging host platform 170 over the computer communications network 130. The instant messaging host platform 170 in turn can support the operation of an instant messaging server 180 managing instant messaging interactions among different collaborators through respective instant messaging clients 190, each coupled to a collaborative computing client 110. As it will be recognized by the skilled artisan, the instant messaging server 180 further can support presence awareness for each different collaborator associated with an instant messaging client 190, for instance by implementing XMPP.

Notably, decision point closure facilitation logic 200 can be coupled to the business process platform host 120. The decision point closure facilitation logic 200 can include program code enabled to facilitate the closure of a decision point in a business process associated with a particular collaborator. Specifically, the program code can be enabled to construct a form addressing the decision point as permitted, for example by XMPP, and to route the form within an instant message to the collaborator associated with the decision point. More specifically, an instant messaging bot 160 can detect through presence awareness when the particular collaborator becomes available, and in response to detecting the presence of the particular collaborator, the form addressing the decision point can be forwarded by way of instant messaging to the particular collaborator thereby driving closure for the decision point.

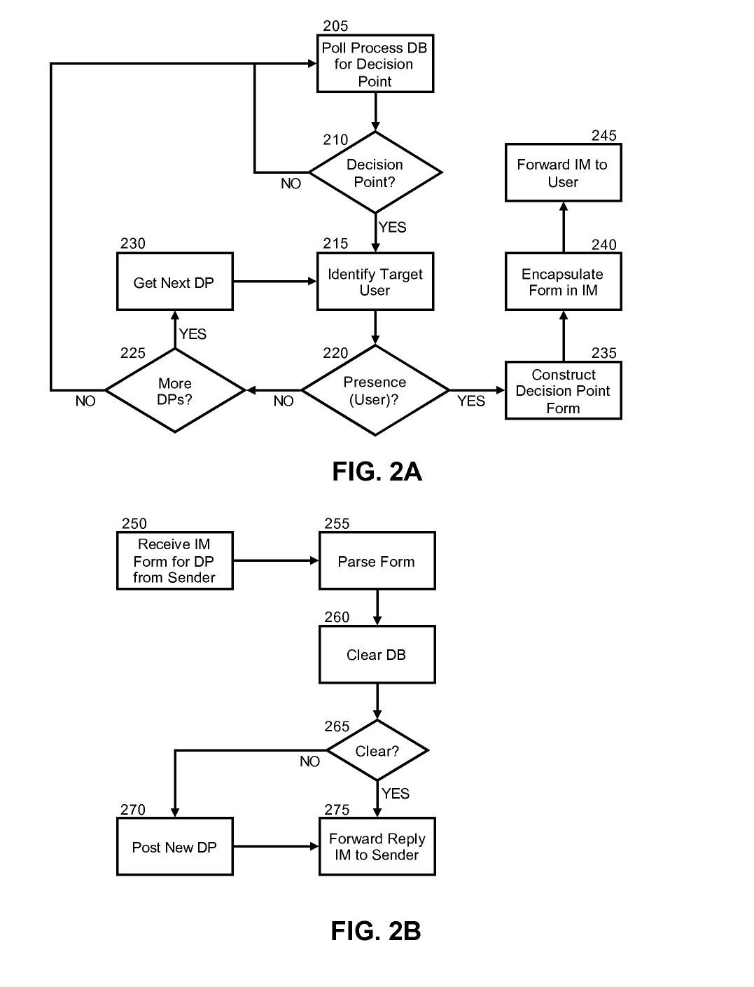

In yet further illustration, FIGS. 2A and 2B, taken together, are a flow chart illustrating a process for instant messaged forms based business process decision point facilitation. Beginning first with FIG. 2A, in block 205, a process database can be polled to identify the occurrence of a decision point in a business process. In decision block 210, if a decision point is encountered, in block 215, the target collaborator for the decision point can be identified. In this regard, the target collaborator for the decision point can be the collaborator required to respond to the decision point in order to clear the decision point to permit the flow of the business process towards closure.

In block 220, it can be determined whether the target collaborator is present through an associated instant messenger. If not, in decision block 225, it can be determined whether any additional decision points remain to be processed in the process data store. If so, in block 230, a next decision point can be retrieved for processing and the process can continue through block 215. Otherwise, the process can continue through block 205 where the process data store can be polled for the occurrence of a decision point. If, in decision block 220, the target collaborator is determined to be present, the process can continue through block 235.

In block 235, a decision point form can be constructed for the decision point. For example, the pertinent question or requisite information for the decision point can be retrieved from the process data store and formatted into an interactive form, for example according to XMPP. Thereafter in block 240 the form can be encapsulated in an instant message and forwarded to the target collaborator in block 245. Upon receipt, the target collaborator can complete the form in order to resolve the decision point, or the target collaborator can reject the form thereby leaving the decision point unresolved. In either case, the form can be returned to the business process by way of an instant message.

Turning now to FIG. 2B, in block 250, a reply instant message can be received from the target collaborator and in block 255 the form can be parsed to identify the input provided by the target collaborator. In block 260, the decision point can be cleared from the process data store and in decision block 265, if the input is determined to be insufficient to drive the business process towards closure, in block 270 a new decision point can be added to the data store to address the input. Otherwise, it will be presumed that the decision point has been resolved and the input will be deemed sufficient to drive the business process towards closure. Finally, in block 275 the reply instant message can be returned to the original sender.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A method for instant messaged forms based business process decision point facilitation, the method comprising:
detecting a decision point in a business process;
identifying a target collaborator for the detected decision point;
applying instant messaging presence awareness for the target collaborator; and,
forwarding a form within an instant message to the target collaborator only when the target collaborator is determined to be present for instant messaging.

2. The method of claim 1, further comprising:
receiving from the target collaborator a reply instant message;
determining from the reply instant message whether the decision point has been resolved; and,
driving the business process towards closure if the reply instant message is determined to have satisfied the decision point.

3. The method of claim 1, wherein forwarding a form within an instant message to the target collaborator only when the target collaborator is determined to be present for instant messaging, comprises:
encapsulating a request for information in a form for an instant message; and,
instant messaging the instant message to the target collaborator.

4. The method of claim 1, wherein applying instant messaging presence awareness for the target collaborator, comprises applying the extensible messaging and presence protocol (XMPP) to detect presence for the target collaborator

5. The method of claim 4, wherein encapsulating a request for information in a form for an instant message, comprises applying the XMPP to create the form within the instant message.

6. An instant messaged forms based business process decision point facilitation data processing system comprising:
an instant messaging server;
a business process host platform supporting a business process through a process manager and a process data store;
an instant messaging bot configured to apply instant messaging presence awareness to a plurality of collaborators associated with the business process; and,
decision point closure facilitation logic coupled to the business process host platform, the logic comprising program code enabled to, in response to encountering a decision point in the business process for a target collaborator, forwarding a form for the decision point within an instant message to the target collaborator only when presence is detected by the instant messaging bot for the target collaborator.

7. The system of claim 6, wherein the form is a form constructed according to the extensible messaging and presence protocol (XMPP).

8. The system of claim 7, wherein the instant messaging bot implements XMPP.

9. A computer program product comprising a computer usable medium having computer usable program code for instant messaged forms based business process decision point facilitation, the computer program product including:
computer usable program code for detecting a decision point in a business process;
computer usable program code for identifying a target collaborator for the detected decision point;
computer usable program code for applying instant messaging presence awareness for the target collaborator; and,
computer usable program code for forwarding a form within an instant message to the target collaborator only when the target collaborator is determined to be present for instant messaging.

10. The computer program product of claim 9, further comprising:
computer usable program code for receiving from the target collaborator a reply instant message;
computer usable program code for determining from the reply instant message whether the decision point has been resolved; and,
computer usable program code for driving the business process towards closure if the reply instant message is determined to have satisfied the decision point.

11. The computer program product of claim 9, wherein the computer usable program code for forwarding a form within an instant message to the target collaborator only when the target collaborator is determined to be present for instant messaging, comprises:
computer usable program code for encapsulating a request for information in a form for an instant message; and,
computer usable program code for instant messaging the instant message to the target collaborator.

12. The computer program product of claim 9, wherein the computer usable program code for applying instant messaging presence awareness for the target collaborator, comprises computer usable program code for applying the extensible messaging and presence protocol (XMPP) to detect presence for the target collaborator

13. The computer program product of claim 12, wherein the computer usable program code for encapsulating a request for information in a form for an instant message, comprises computer usable program code for applying the XMPP to create the form within the instant message.
